(19) United States
(12) Patent Application Publication
(10) Pub. No.: US 2026/0083143 A1
(43) Pub. Date: Mar. 26, 2026

(54) SMOKING MACHINE

(71) Applicant: RUIXIN QIU, Shenzhen (CN)

(72) Inventor: RUIXIN QIU, Shenzhen (CN)

(21) Appl. No.: 18/911,686

(22) Filed: Oct. 10, 2024

(30) Foreign Application Priority Data
Sep. 24, 2024 (CN) 202411331352.5

(51) Int. Cl. A23B 4/052

(52) U.S. Cl. CPC A23B 4/052

(57) ABSTRACT

A smoking machine is provided, which includes a smoke exhaust device and a smoke generation device; the smoke generation device is detachably connected to the smoke exhaust device; the smoke exhaust device includes a smoke exhaust outlet, a casing, a circuit board, a battery, a flue channel component, a connection part, a rear cover, and a button; the smoke generation device includes a filter screen, a housing for the smoke generation device, an insulation element, a circuit board for the smoke generation device, a heating element, and a bottom housing for the smoke generation device. The smoking machine provided in the present application has a compact overall structure and occupies a small area, it can be worked handheld, convenient and flexible, more suitable for handling a small target.

### CROSS-REFERENCE TO RELATED APPLICATIONS

This application claims priority to Chinese Patent Application No. 202411331352.5, filed on Sep. 24, 2024, which is hereby incorporated by reference in its entirety.

### TECHNICAL FIELD

The present disclosure relates to the field of smoking device technologies, and in particular, to a smoking machine.

### BACKGROUND

With the development of the times, people are increasingly pursuing a higher level of diet, not only demanding higher standards for food taste, but also for the pleasure that food brings. Therefore, in current diets, people often add spices to ingredients to give them a sense of pleasure and happiness, and one important way to add spices to ingredients is through smoking. For example, the smoke from burning fruit wood can be used to smoke dishes, giving them an aroma of fruit wood. Or the smoke from burning pine wood can be used to smoke drinks, giving them the scent of pine wood.

At present, there are specialized smoking devices for processing ingredients, but the existing smoking devices have the following shortcomings in practical applications:
1) the existing smoking devices are often large, occupying a large area, and not portable and flexible enough;
2) the existing smoking equipment is more adept at handling large amounts of food, while handling small amounts of food is often difficult to control and can result in waste.

### SUMMARY

The present application aims to solve at least one of the above technical problems by providing a smoking machine to ensure that it meets requirements of improving flexibility and convenience of a use of the smoking machine.

The present application provides a smoking machine, which includes a smoke exhaust device and a smoke generation device; the smoke generation device is detachably connected to the smoke exhaust device;
the smoke exhaust device includes a smoke exhaust outlet, a casing, a circuit board, a battery, a flue channel component, a connection part, a rear cover, and a button;
the smoke generation device includes a filter screen, a housing for the smoke generation device, an insulation element, a circuit board for the smoke generation device, a heating element, and a bottom housing for the smoke generation device.

In some embodiments of the present application, the bottom housing for the smoke generation device includes a bottom housing connection hole and a heating chamber; the housing for the smoke generation device is fixedly connected to the bottom housing for the smoke generation device; the insulation element, the circuit board for the smoke generation device, and the heating element are located in an internal space after a connection between the housing for the smoke generation device and the bottom housing for the smoke generation device.

In some embodiments of the present application, the heating element is located inside the heating chamber, the insulation element is sleeved on the heating chamber, a position of the filter screen corresponds to the heating chamber, and the filter screen is on the insulation element; the heating element is electrically connected to the circuit board for the smoke generation device.

In some embodiments of the present application, the filter screen has a filtering function; the insulation element is made of ceramic material; the heating element is suspended in the air;
the housing for the smoke generation device is provided with a through hole for the smoke generation device, a positioning block for the smoke generation device, a connection clamp hole for the smoke generation device, and a marking for the smoke generation device; the connection part is provided with a marking for the connection part, an electrical connector, a clamp block for the connection part, a positioning block for the connection part, a fixing hole for the connection part, and a housing clamp hole;
the circuit board for the smoke generation device is provided with a contact terminal, and a position of the contact terminal corresponds to the through hole for the smoke generation device; the contact terminal is extended outside the housing for the smoke generation device through the through hole for the smoke generation device and is connected to the electrical connector; the contact terminal has elasticity.

In some embodiments of the present application, the marking for the connection part matches with the marking for the smoke generation device, the clamp block for the connection part matches the connection clamp hole for the smoke generation device, the positioning block for the connection part matches the positioning block for the smoke generation device, the connection part is connected to the smoke generation device.

In some embodiments of the present application, the circuit board, the battery, the flue channel component, and the button are fixedly provided in the casing; the smoke exhaust outlet is fixedly installed in front of the casing, and the rear cover is fixedly installed behind the casing; the smoke exhaust outlet is connected to the flue channel component; and the connection part is connected to the smoke generation device; the flue channel component includes a smoke exhaust pipe, a smoke exhaust driving device, filter cotton, and an elastic element; the smoke exhaust driving device is provided with a driving housing, a curved flue channel, and a blower; the curved flue channel and the blower are located inside the driving housing, the driving housing fixes the blower; the curved flue channel is integrally formed by the driving housing.

In some embodiments of the present application, the connection part is provided with a smoke pipe for the connection part; the filter cotton is located inside the smoke pipe for the connection part; the smoke exhaust driving device is inserted into the smoke pipe for the connection part, closely attached to the filter cotton, and is sleeved with the elastic element at a bottom thereof; a top of the smoke exhaust driving device is connected to the smoke exhaust pipe.

In some embodiments of the present application, a bottom of the smoke exhaust pipe is capable of being sleeved with the elastic element; a check valve is provided on the filter cotton, or the filter cotton is replaced with the check valve.

In some embodiments of the present application, the casing includes an upper casing and a lower casing; the lower casing is provided with a driving installation part and a smoke exhaust pipe placement component; the smoke exhaust driving device is placed on the driving installation part, and the smoke exhaust pipe is placed on the smoke exhaust pipe placement component.

In some embodiments of the present application, an interface and an indicator light are connected on the circuit board; the smoking machine is configured to smoke.

The smoking machine of the present application has a compact overall structure and occupies a small area, it can be worked handheld, convenient and flexible, more suitable for handling small targets.

### BRIEF DESCRIPTION OF DRAWINGS

FIG. 1 is a schematic structural diagram of a smoking machine provided in the present application.

FIG. 2 is an explosion schematic structural diagram of the smoking machine provided in the present application.

FIG. 3 is an explosion schematic structural diagram of a smoke generation device provided in the present application.

FIG. 4 is a schematic sectional view of the smoke generation device provided in the present application.

FIG. 5 is a schematic structural diagram of a heating element in a smoke exhaust device provided by the present application.

FIG. 6 is an explosion schematic diagram of the smoke exhaust device provided in the present application.

FIG. 7 is a first schematic structural diagram of a connection part provided in the present application.

FIG. 8 is a second schematic structural diagram of the connection part provided in the present application.

FIG. 9 is a schematic structural diagram of a lower casing provided by the present application.

FIG. 10 is a schematic structural diagram of a flue channel component provided in the present application.

FIG. 11 is a schematic diagram showing an operation of the smoking machine provided in the present application.

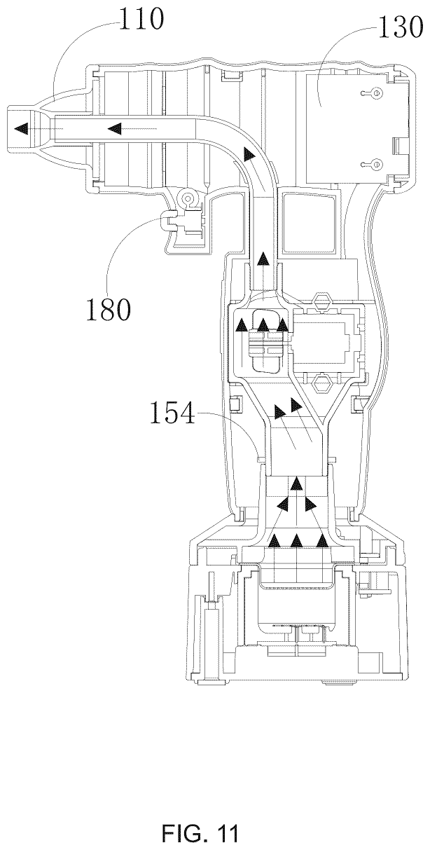

Numeral reference: 10—smoke exhaust device; 110—smoke exhaust outlet; 120—casing; 121—upper casing; 122—lower casing; 1221—casing clamp block; 1222—casing connection block; 1223—casing connection hole; 1224—driving installation part; 1225—smoke exhaust pipe placement component; 1226—smoke exhaust outlet connection hole; 130—circuit board; 140—battery; 150—flue channel component; 151—smoke exhaust pipe; 152—smoke exhaust driving device; 1521—driving housing; 1522—curved flue channel; 1523—blower; 153—filter cotton; 154—elastic element; 160—connection part; 161—marking for the connection part; 162—electrical connector; 163—clamp block for the connection part; 164—positioning block for the connection part; 165—fixing hole for the connection part; 166—smoke pipe for the connection part; 167—housing clamp hole; 170—rear cover; 180—button; 20—smoke generation device; 210—filter screen; 220—housing for the smoke generation device; 221—through hole for the smoke generation device; 222—positioning block for the smoke generation device; 223—connection clamp hole for the smoke generation device; 224—marking for the smoke generation device; 230—insulation element; 240—circuit board for the smoke generation device; 241—contact terminal; 250—heating element; 260—bottom housing for the smoke generation device; 261—bottom housing connection hole; 262—heating chamber.

### DESCRIPTION OF EMBODIMENTS

The following will provide a clear and complete description of the technical solution in the embodiments of the present application, combined with the accompanying drawings. Obviously, the described embodiments are only a part of the embodiments of the present application, not all of them. Based on the embodiments in the present application, all other embodiments obtained by those skilled in the art without creative work are within the protection scope of the present application.

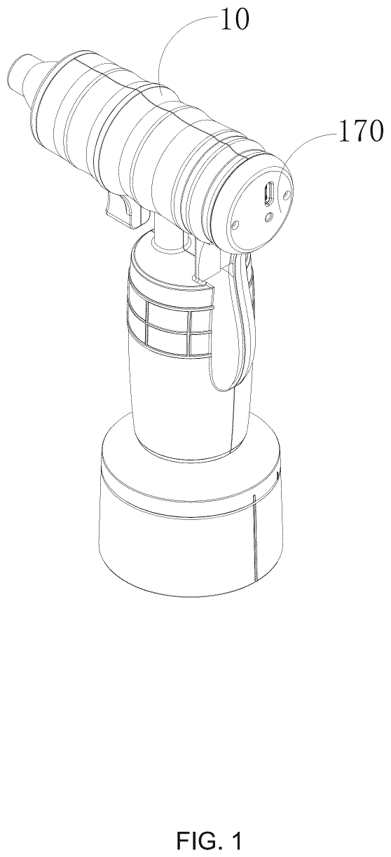

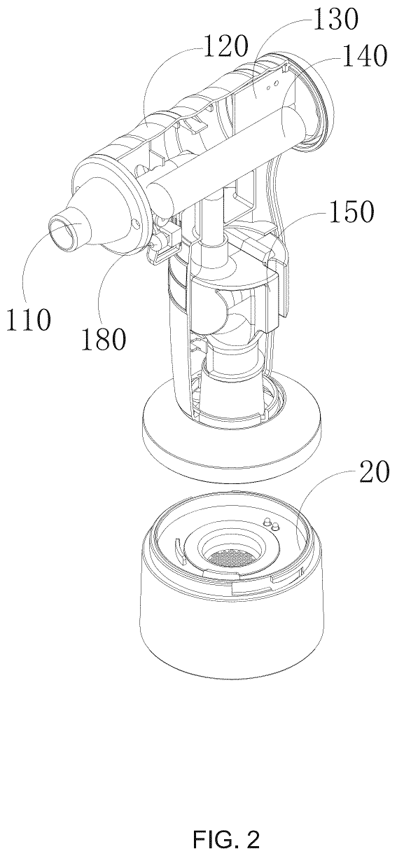

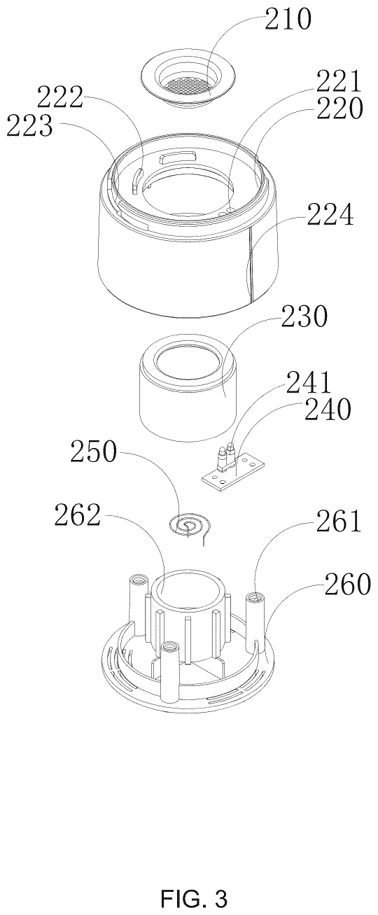

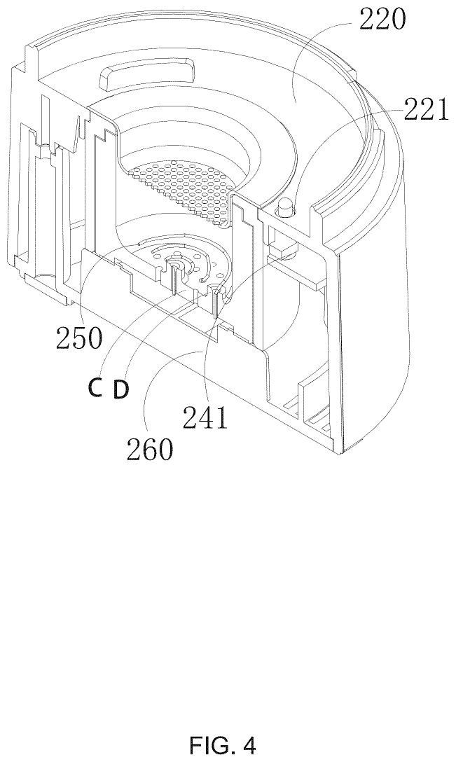

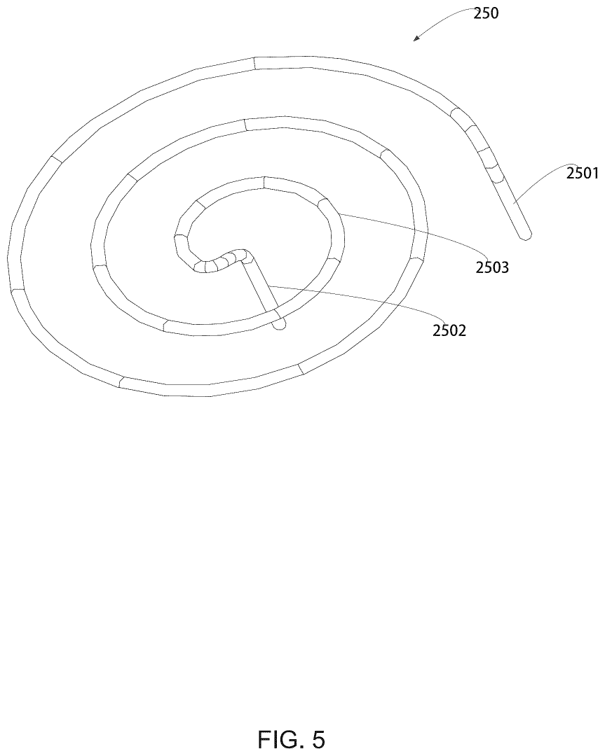

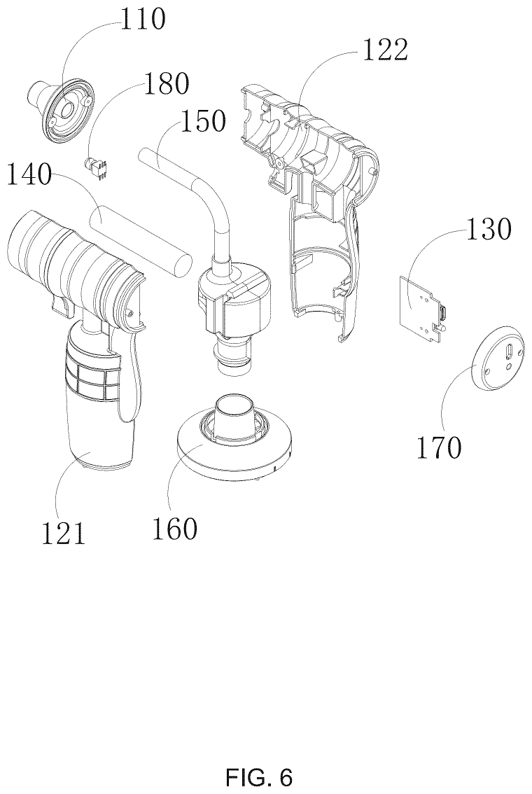

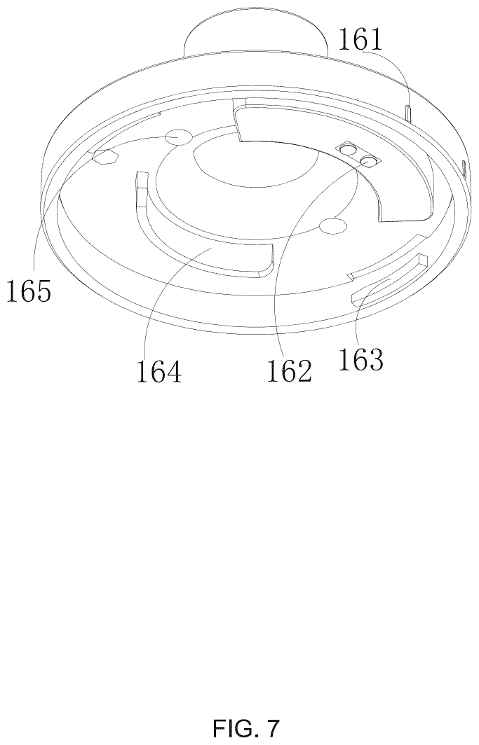

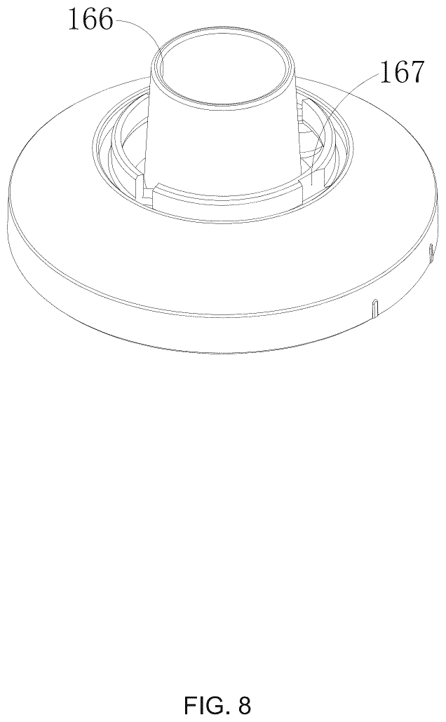

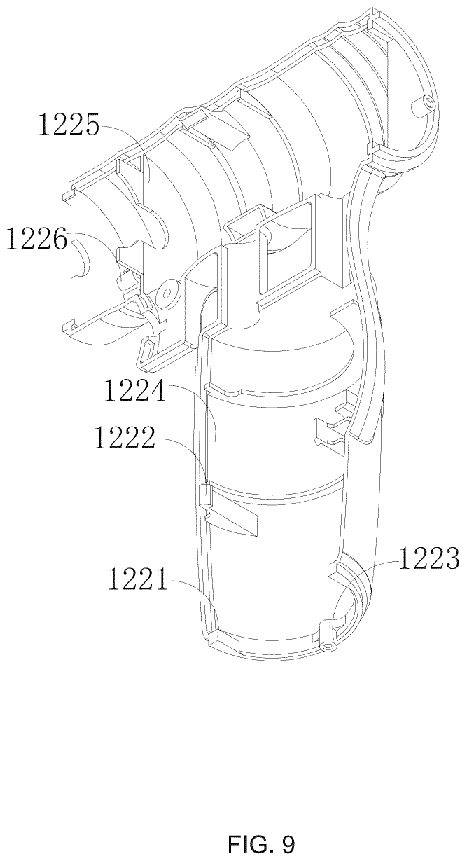

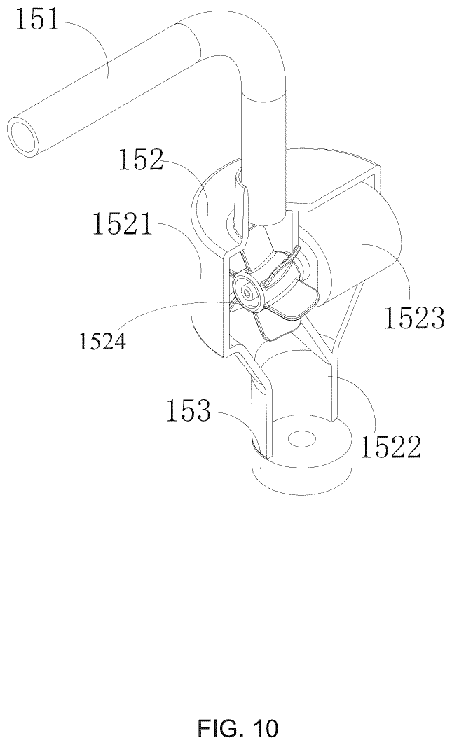

Referring to FIGS. 1-10, a smoking machine includes a smoke exhaust device 10 and a smoke generation device 20. The smoke generation device 20 can be detachably connected to the smoke exhaust device 10, in an implementation mode, provided at a bottom of the smoke exhaust device 10. The smoke generation device 20 is configured to generate smoke, and the smoke exhaust device 10 is configured to receive smoke and controllably delivers it to a target for smoking.

The smoke exhaust device 10 includes a smoke exhaust outlet 110, a casing 120, a circuit board 130, a battery 140, a flue channel component 150, a connection part 160, a rear cover 170, and a button 180. The circuit board 130, the battery 140, the flue channel component 150, and the button 180 are fixedly provided inside the casing 120, the smoke exhaust outlet 110 is fixedly provided in front of the casing 120, and the rear cover 170 is fixedly provided behind the casing 120. The smoke exhaust outlet 110 is connected to the flue channel component 150, and the connection part 160 is connected to the smoke generation device 20. The smoke generated by the smoke generation device 20 is discharged through the connection part 160 and the flue channel component 150 through the smoke exhaust outlet 110. The button 180 is configured to control start and stop of the entire smoking machine.

The circuit board 130 is electrically connected to the battery 140, the flue channel component 150, the connection part 160, and the button 180, and is also electrically connected to the smoke generation device 20 through the connection part 160. The circuit board 130 can control the flue channel component 150 and the smoke generation device 20. The circuit board 130 is connected with an interface (not shown in the figure) and an indicator light (not shown in the figure), and a position of the circuit board 130 inside the casing 120 corresponds to the rear cover 170. The rear cover 170 is provided with holes corresponding to the interface (not shown in the figure) and the indicator light (not shown in the figure). The interface (not shown in the figure) is configured to receive external power, and the indicator light (not shown in the figure) can be configured to display a working state of the smoking machine and/or a level state of the battery.

The smoke generation device 20 includes a filter screen 210, a housing for the smoke generation device 220, an insulation element 230, a circuit board for the smoke generation device 240, a heating element 250, and a bottom housing for the smoke generation device 260. The bottom housing for the smoke generation device 260 includes a bottom housing connection hole 261 and a heating chamber 262. The housing for the smoke generation device 220 is provided with a through hole for the smoke generation device 221, a positioning block for the smoke generation device 222, a connection clamp hole for the smoke generation device 223, and a marking for the smoke generation device 224.

The housing for the smoke generation device 220 is connected to the bottom housing for the smoke generation device 260. In an implementation mode, the bottom housing connection hole 261 is fixedly connected to the housing for the smoke generation device 220 and the bottom housing for the smoke generation device 260 with a bolt or a screw. The insulation element 230, the circuit board for the smoke generation device 240, and the heating element 250 are located in an internal space after a connection between the housing for the smoke generation device 220 and the bottom housing for the smoke generation device 260. In an implementation mode, the heating element 250 is located inside the heating chamber 262, and the insulation element 230 is sleeved in the heating chamber 262. A position of the filter screen 210 corresponds to the heating chamber 262, and the filter screen 210 is on the insulation element 230. The heating element 250 is electrically connected to the circuit board for the smoke generation device 240 and controlled by the circuit board for the smoke generation device 240.

Spice substance is placed into the heating chamber 262, below the filter screen 210. The filter screen 210 is configured to filter solid particles in the smoke, thereby avoiding unwanted substances or harmful substances to the human body, and preventing these substances from entering the target. The heating element 250 emits heat, heats the spice substance, and produces smoke. Providing with the insulation element 230 renders the heating chamber 262 to be a relatively independent space, allowing heat to be concentrated as much as possible inside the heating chamber 262 and preventing heat dissipation. This not only improves heating efficiency, but also prevents an emitted heat from affecting the device components outside the heating chamber 262. The insulation element 230 is made of ceramic material. The heating element 250 is suspended in the air to more fully heat the spice substance, reduce heat loss, improve efficiency, and achieve energy savings.

Where, a step portion D is provided on a bottom wall C of the heating chamber 262, and one end of the heating element 250 penetrates the step portion D and enters an accommodating chamber in a spiral manner.

Where, in an implementation mode, there are two step parts D, and one step part D can be provided at a center position of the bottom wall C to ensure that the heating element 250 is located at the center position of the bottom wall C. In an implementation mode, the heating element 250 is arranged in a spiral manner along a plane parallel to the bottom wall C.

Where, the heating element 250 is formed by winding a whole heating wire, which includes a positive electrode part 2501, a negative electrode part 2502, and a spiral part 2503. The positive electrode part 2501 and the negative electrode part 2502 are respectively arranged perpendicular to a winding plane of the spiral part 2503.

Where, the positive electrode portion 2501 and the negative electrode part 2502 respectively penetrate the bottom wall C and are electrically connected to the circuit board for the smoke generation device 240. The spiral part 2503 is suspended and supported by the positive electrode part 2501 and the negative electrode part 2502. Where, one of the positive electrode part 2501 and the negative electrode part 2502 is provided corresponding to the center position of the bottom wall C.

Therefore, by spiral winding the heating element 250 into a circular disk shape, the heating element 250 can be evenly distributed at a bottom of the heating chamber 262, which can improve the heating uniformity of the heating element 250 in the heating chamber 262. This can achieve uniform heating of the material in the smoking machine and fill it with smoke, thereby improving a utilization efficiency of the material.

The circuit board for the smoke generation device 240 is provided with a contact terminal 241, a position of the contact terminal 241 corresponds to the through hole for the smoke generation device 221. The contact terminal 241 is extended outside the housing for the smoke generation device 220 through the through hole for the smoke generation device 221. And the contact terminal 241 has elasticity, which is more suitable for that the smoke generation device 20 is rotatably connected to the connection part 160. The circuit board for the smoke generation device 240 can be fixed and provided inside the housing for the smoke generation device 220 by a screw or a bolt, or can be fixed and installed by providing support components inside the housing for the smoke generation device 220.

The connection part 160 is provided with a marking for the connection part 161, an electrical connector 162, a clamp block for the connection part 163, a positioning block for the connection part 164, a fixing hole for the connection part 165, a smoke pipe for the connection part 166, and a housing clamp hole 167. When connecting the smoke generation device 20 to the connection part 160, the marking for the connection part 161 matches the marking for the smoke generation device 224, the clamp block for the connection part 163 matches the connection clamp hole for the smoke generation device 223, and the positioning block for the connection part 164 matches the positioning block for the smoke generation device 222, rendering that the connection part 160 is easy and disassembly connected to the smoke generation device 20. The circuit board 130 is electrically connected to the electrical connector 162, and the contact terminal 241 is connected to the electrical connector 162, so that the circuit board 130 controls the circuit board for the smoke generation device 240, and thus controls the heating element 250. The casing 120 includes an upper casing 121 and a lower casing 122. The lower casing 122 is provided with a casing clamp block 1221, a casing connection block 1222, a casing connection hole 1223, a driving installation part 1224, a smoke exhaust pipe placement component 1225, and a smoke exhaust outlet connection hole 1226. The casing connection block 1222 is configured to connect the upper casing 121. The casing clamp block 1221 is matched with the housing clamp hole 167 so as to connect the connection part 160 to a bottom of the casing 120, and the fixing hole for the connection part 165 and the casing connection hole 1223 are connected by bolts or screws to further strengthen a connection strength.

The flue channel component 150 includes a smoke exhaust pipe 151, a smoke exhaust driving device 152, filter cotton 153, and an elastic element 154. The smoke exhaust driving device 152 is provided with a driving housing 1521, a curved flue channel 1522, and a blower 1523. The curved flue channel 1522 and the blower 1523 are located inside the driving housing 1521, and the driving housing 1521 fixes the blower 1523. The curved flue channel 1522 is integrally formed from the driving housing 1521.

The blower 1523 is connected with a fan 1524, a rotation axis of the fan 1524 is perpendicular to an axis direction of an air duct 1021. In this embodiment, a rotation of the fan 1524 can drive the flow along an air outlet inside the heating chamber 262 into the curved flue channel 1522, and further spray out along the curved flue channel 1522. As the rotation axis of the fan 1524 is perpendicular to the axis direction of the curved flue channel 1522 (a direction of smoke transmission), a stability of smoke emission can be improved.

The filter cotton 153 is located inside the smoke pipe for the connection part 166. The smoke exhaust driving device 152 is inserted into the smoke pipe for the connection part 166, closely attached to the filter cotton 153 and is sleeved with an elastic element 154 at a bottom of the smoke exhaust driving device 152 to enhance a sealing effect. A top of the smoke exhaust driving device 152 is connected to the smoke exhaust pipe 151. If it is necessary to enhance the sealing effect, an elastic element 154 can also be sleeved at a bottom of the smoke exhaust pipe 151. The filter cotton 153 has a function of filtering e-liquid in the smoke, further filtering unwanted substances or harmful substances to the human body into the target. The smoke enters the curved flue channel 1522 through the filter cotton 153 and is driven by the blower 1523 to enter the smoke exhaust pipe 151. The smoke exhaust driving device 152 is placed on the driving installation part 1224, and the smoke exhaust pipe 151 is placed on the smoke exhaust pipe placement component 1225.

If a user want to have smoke prevention function, a check valve can be provided at a bottom of the smoke exhaust driving device 152 or change a cross-sectional area of the flue channel to change a pressure to achieve smoke prevention effect.

The workflow of this device:
firstly, the spice substance is placed into the heating chamber 262;
then the smoke generation device 20 is connected to the smoke exhaust device 10;
the smoke exhaust device 10 is aimed at the target and the button 180 is pressed;
the button 180 will transmit a start signal to the circuit board 130, which will then transmit the control signal to the circuit board for the smoke generation device 240, the circuit board for the smoke generation device 240 will control the heating element 250 to heat the fragrance substance and generate smoke;
the circuit board 130 transmits the control signal to the circuit board for the smoke generation device 240; at the same time or after a specified time, the circuit board 130 transmits the control signal to the blower 1523, which operates to exhaust smoke from the smoke exhaust outlet 110.

The beneficial effects of this device are that it has a compact overall structure and occupies a small space, can be worked handheld, convenient and flexible, more suitable for handling small targets.

The above are only embodiments of the present application and do not limit the scope of the present application. Any equivalent structure or equivalent process transformation made using the content of the present application and drawings, or directly or indirectly applied in other related technical fields, are also included in the protection scope of the present application.

What is claimed is:

1. A smoking machine, comprising a smoke exhaust device and a smoke generation device; the smoke generation device is detachably connected to the smoke exhaust device;
the smoke exhaust device comprises a smoke exhaust outlet, a casing, a circuit board, a battery, a flue channel component, a connection part, a rear cover, and a button;
the smoke generation device comprises a filter screen, a housing for the smoke generation device, an insulation element, a circuit board for the smoke generation device, a heating element, and a bottom housing for the smoke generation device.

2. The smoking machine according to claim 1, wherein the bottom housing for the smoke generation device comprises a bottom housing connection hole and a heating chamber;
the housing for the smoke generation device is fixedly connected to the bottom housing for the smoke generation device;
the insulation element, the circuit board for the smoke generation device, and the heating element are located in an internal space after a connection between the housing for the smoke generation device and the bottom housing for the smoke generation device.

3. The smoking machine according to claim 2, wherein the heating element is located inside the heating chamber, the insulation element is sleeved on the heating chamber,
a position of the filter screen corresponds to the heating chamber, and the filter screen is on the insulation element;
the heating element is electrically connected to the circuit board for the smoke generation device.

4. The smoking machine according to claim 3, wherein the filter screen has a filtering function; the insulation element is made of ceramic material; the heating element is suspended in the air;
the housing for the smoke generation device is provided with a through hole for the smoke generation device, a positioning block for the smoke generation device, a connection clamp hole for the smoke generation device, and a marking for the smoke generation device;
the connection part is provided with a marking for the connection part, an electrical connector, a clamp block for the connection part, a positioning block for the connection part, a fixing hole for the connection part, and a housing clamp hole;
the circuit board for the smoke generation device is provided with a contact terminal, and a position of the contact terminal corresponds to the through hole for the smoke generation device;
the contact terminal is extended outside the housing for the smoke generation device through the through hole for the smoke generation device and is connected to the electrical connector;
the contact terminal has elasticity.

5. The smoking machine according to claim 4, wherein the marking for the connection part matches with the marking for the smoke generation device,
the clamp block for the connection part matches the connection clamp hole for the smoke generation device,
the positioning block for the connection part matches the positioning block for the smoke generation device,
the connection part is connected to the smoke generation device.

6. The smoking machine according to claim 1, wherein the circuit board, the battery, the flue channel component, and the button are fixedly provided in the casing,
the smoke exhaust outlet is fixedly provided in front of the casing, and the rear cover is fixedly provided behind the casing;
the smoke exhaust outlet is connected to the flue channel component, and the connection part is connected to the smoke generation device;
the flue channel component comprises a smoke exhaust pipe, a smoke exhaust driving device, filter cotton, and an elastic element;
the smoke exhaust driving device is provided with a driving housing, a curved flue channel, and a blower;
the curved flue channel and the blower are located inside the driving housing,
the driving housing fixes the blower;
the curved flue channel is integrally formed by the driving housing.

7. The smoking machine according to claim 6, wherein the connection part is provided with a smoke pipe for the connection part;
the filter cotton is located inside the smoke pipe for the connection part;
the smoke exhaust driving device is inserted into the smoke pipe for the connection part, closely attached to the filter cotton, and is sleeved with the elastic element at a bottom thereof;
a top of the smoke exhaust driving device is connected to the smoke exhaust pipe.

8. The smoking machine according to claim 7, wherein a bottom of the smoke exhaust pipe is capable of being sleeved with the elastic element;
a check valve is provided on the filter cotton, or the filter cotton is replaced with the check valve.

9. The smoking machine according to claim 8, wherein the casing comprises an upper casing and a lower casing;
the lower casing is provided with a driving installation part and a smoke exhaust pipe placement component;
the smoke exhaust driving device is placed on the driving installation part, and the smoke exhaust pipe is placed on the smoke exhaust pipe placement component.

10. The smoking machine according to claim 1, wherein an interface and an indicator light are connected on the circuit board; the smoking machine is configured to smoke.
